(19) United States
(12) Patent Application Publication
(10) Pub. No.: US 2023/0266795 A1
(43) Pub. Date: Aug. 24, 2023

(54) A SMART WEARABLE PRODUCT COMPATIBLE WITH FABRIC

(71) Applicant: TIM AKILLI KIYAFETLERI VE BILISIM TEKNOLOJISI ANONIM SIRKETI, Istanbul (TR)

(72) Inventors: Rahim ONER, Istanbul (TR); Kadir DEMIRCIOGLU, Istanbul (TR)

(73) Assignee: TIM AKILLI KIYAFETLERI VE BILISIM TEKNOLOJISI ANONIM SIRKETI, Istanbul (TR)

(21) Appl. No.: 18/015,964

(22) PCT Filed: Apr. 6, 2021
(86) PCT No.: PCT/TR2021/050316

§ 371 Date: Jan. 13, 2023

(30) Foreign Application Priority Data
Jul. 14, 2020 (TR) 2020/11169

(51) Int. Cl. G06F 1/16

(52) U.S. Cl. CPC G06F 1/163; G06F 1/1635

(57) ABSTRACT

A smart product used for tasks such as data collection and data transmission, etc. in the industry without restricting the movement of the user/operator includes at least one textile material which is completely or partially wearable by the user/operator, and which has a sensor thereon for data collection, at least one touch keypad which is provided on or under the upper surface of the textile material, and which is for enabling manual data entry for transmission of data collected via the sensor, a microcontroller which can sense touches on the keys and which is used for transmitting them outside via an electronic interface, at least one electronic card which is flexible and placed inside the textile material and which is for electrical communication between the microcontroller and the touch keypad.

### CROSS REFERENCE TO THE RELATED APPLICATIONS

This application is the national phase entry of International Application No. PCT/TR2021/050316, filed on Apr. 6, 2021, which is based upon and claims priority to Turkish Patent Application No. 2020/11169, filed on Jul. 14, 2020, the entire contents of which are incorporated herein by reference.

### TECHNICAL FIELD

The present invention relates to a smart glove which has the ability to stretch in accordance with body movement in wearable products such as gloves, etc. and which is compatible with the fabric.

### BACKGROUND

In the current technique, there are smart garments (smart gloves, etc.) which have keys and sensors thereon and are used in the fields such as monitoring systems for operators, error prevention solutions etc., and which are generally worn on the hand area. Data are received from the sensors on the smart garment and this data can be collected in a cloud computer network. In the state of the art, there are keyboard and/or data entry devices which can be worn on the hand by various methods or keyboard-like designs for the purpose of controlling various devices by hand. In the current designs, there are components which are rigid, hard and disturbing to the user, and these components prevent the user from moving comfortably and they are not suitable for long-term use. Furthermore, the smart garments in the current technique cause heating and perspiration on the hand/body. Additionally they are not ergonomic since insulation with the hand/body is not made.

Another technical problem in the current technique is that the keypad in wearable garments disturbs the user/operator visually and tactually. In particular, the keypad in the form of an elevation on the glove can be caught somewhere and damaged. In addition, in products with an unprotected screen that is directly outside, the touch sensor part can easily be damaged and deformed.

United States document U.S. Pat. No. 7,959,351, an application known in the state of the art, discloses a wearable smart hand garment in which data such as time can be seen on the hand and which has a keypad thereon. In the said document, the rigid screen and the electronic card part had to be placed in the part between the thumb and index finger in order not to disturb the user. Furthermore, in the said document, the keypad is left outside and it is unprotected and easily deformable due to its design.

### SUMMARY

The objective of the present invention is to provide a wearable smart product which is wearable by the user/operator, is used for data collection and data transmission in the industry, and does not contain any electronic parts.

The objective of the present invention is to provide a wearable smart product which is integral (embroidered on the fabric) with the textile material (garment fabric) to be worn by the user and does not disturb the user visually and tactually.

The objective of the present invention is to provide a wearable smart product which is not in the form of an elevation or a protrusion, and does not disturb the user.

### BRIEF DESCRIPTION OF THE DRAWINGS

A wearable smart product developed in order to achieve the objective of the present invention is illustrated in the accompanying figures, wherein

FIG. 1 is the top outer view of the wearable smart product according to the present invention.

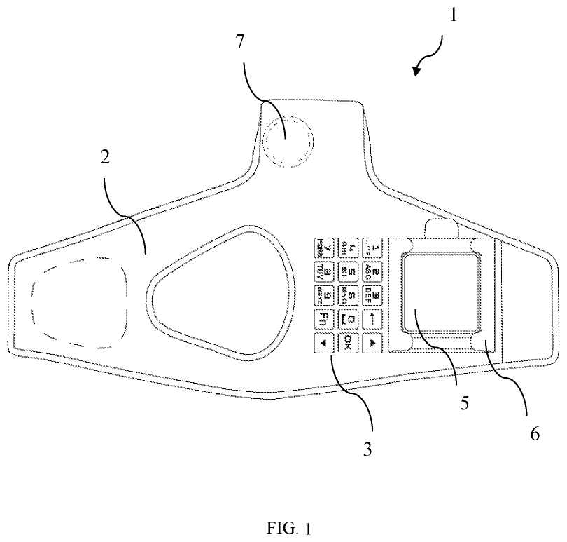

FIG. 2 is the exploded view of the inner part of the wearable smart product according to the present invention.

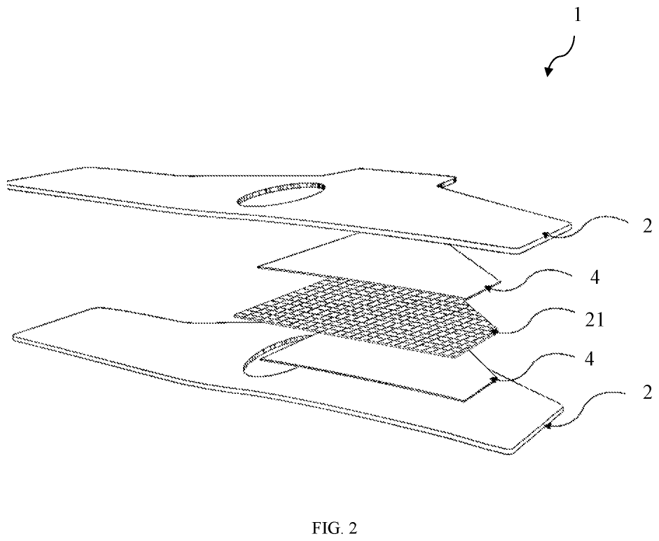

The components shown in the figures are each given reference numerals as follows:

8. Smart product

9. Textile material

21. Sensor

10. Keypad

11. Insulation layer

12. Battery

13. Battery holder

14. Button

### DETAILED DESCRIPTION OF THE EMBODIMENTS

A smart product (1), which is used for tasks such as data collection and data transmission, etc. in the industry without restricting the movement of the user/operator, includes
at least one textile material (2) which is completely or partially wearable by the user/operator, and which has a sensor (21) therein/thereon for data collection,
at least one touch keypad (3) which is provided on or under the upper surface of the textile material (2), and which is for enabling manual data entry for transmission of data collected via the sensor (21),
a microcontroller which can sense touches on the keys and which is used for transmitting them outside via an electronic interface,
at least one electronic card which is placed inside the textile material (2), is flexible and which is for electrical communication between the microcontroller and the touch keypad (3).

The smart product (1) of the present invention includes a textile material (2) (flexible materials such as plastic or the like, all kinds of fabrics, etc.) which is provided on at least one part of a product worn by the user, a touch keypad (3) which is provided on the textile material (2), an electronic card which is provided inside the textile material (2) and is flexible suitable for the textile material (2), and a microcontroller which is used for transmitting the data entered via the keys and the information received from the sensors to the outside. The touch keypad (3) is located on the upper side of the textile product and the microcontroller located at the bottom of the touch keypad (3) senses the touches on the keypad (3). Since the electronic card is included in the textile product and it is bendable/flexible with its elastic structure, it is compatible with the textile product and does not create a restriction for the movement of the user.

In one embodiment of the invention, the electronic card base surface is flexible. In another embodiment of the invention, the electronic card base is Polyamide, Polyether ketone or transparent conductive polyester.

In one embodiment of the present invention, the electronic card base surface has a flexible structure by means of applying a conductive ink on the fabric.

In an embodiment of the present invention, the touch keypad (3) is embroidered with conductive yarns on the textile material (2) (fabric, etc.). In another embodiment of the present invention, the yarn is integrated on the textile material (2) by means of embroidery, horizontal embroidery, weaving and sewing. The end parts of the conductive yarns are connected to the microcontroller circuit.

In the smart product (1), a capacitive area is created with the conductive yarns and the capacitive area which is created is supported by a microcontroller that can sense touch on the keys. Touch keypad (3), which is embroidered to the textile product with conductive yarns, does not disturb the ergonomics and the feeling of fabric since it is integrated with the fabric by being embroidered to the fabric with completely conductive yarns. The smart product (1) is washable and it can be crumpled together with the conductive yarns. Since key sensing method is capacitive, it can be realized in all kinds of textile products.

In one embodiment of the present invention, there are conductive key structures on the flexible electronic card, which will facilitate the capacitive sensing of touches on the keypad (3). The keys do not create any elevation due to the flexible electronic card and capacitive operation technique.

In an embodiment of the present invention, there is at least one insulation layer (4) coated on the lower and/or upper surface of the flexible electronic card. By means of the insulation layer (4), the electronic card is physically insulated and a protection is provided against moisture and/or wetting that may occur due to reasons such as sweating, liquid coming from the outer environment, etc. In another embodiment of the invention, the insulation coating is formed of a thin film and a band.

In one embodiment of the present invention, the touch keypad (3) is configured on a flexible surface (it has a flexible structure) and can flex and bend to be compatible with the textile product. In this way, the touch keypad (3) does not restrict the movements of the user.

A smart product (1), which is used for tasks such as data collection and data transmission, etc. in the industry without restricting the movement of the user/operator and which is used by being mounted on at least one textile material completely or partially wearable by the user/operator, includes
at least one electronic card which is flexible and used by being placed inside the textile product material (textile product such as plastic or similar flexible materials, all kinds of fabrics, etc.) and which is for electrical communication between the electronic components,
at least one touch keypad (3) which is positioned on the upper part of the electronic card such that it will be on the upper surface of a textile material (2), and which is for enabling manual data entry for transmission of the data,
a microcontroller which can sense touches on the keys and which is used for transmitting them outside via an electronic interface.

In an embodiment of the present invention, the lower part of the touch keypad (3) is embroidered on the textile product with conductive yarn. The part under the touch keypad (3) is embroidered on the textile with conductive yarn and acts as a sensor under capacitive effect. This sensor which is created is affected by the approach of objects with capacitive load such as the human body, this effect is transferred to the electronic unit through the conductive yarns and thus information about the touch of the finger is obtained.

For this reason, the product is completely embroidered on the fabric, and it does not contain any electronics under it. Visuals of the keys are embroidered on the material from which the glove is made by any method used in textile materials (2).

In one embodiment of the present invention, the touch keypad (3) is a touch keypad which allows the user to enter alphanumeric data.

In one embodiment of the invention, the textile product is a glove.

In one embodiment of the invention, the textile product is a wearable object.

In one embodiment of the present invention, there is at least one battery holder (6) and at least one battery (5) which is placed in the battery holder (6) on the textile product. The battery (5) is used for the electrical energy required for the operation of the touch keypad (3) and other components.

In one embodiment of the invention, there is at least one button (7) on the textile product. The said button (7) can be used for operations such as the user entering data, etc.

What is claimed is:

1. A smart product configured for tasks comprising a data collection and a data transmission in an industry without restricting a movement of a user/operator, comprising
at least one textile material, wherein the at least one textile material is completely or partially wearable by the user/operator, and the at least one textile material has a sensor thereon for the data collection,
at least one touch keypad, wherein the at least one touch keypad is provided on or under an upper surface of the at least one textile material, and the at least one touch keypad is for enabling a manual data entry for a transmission of data collected via the sensor,
a microcontroller, wherein the microcontroller is configured to sense touches on keys and microcontroller is configured for transmitting the touches outside via an electronic interface, and wherein
at least one electronic card, wherein the at least one electronic card is placed inside the at least one textile material (2), the at least one electronic card is flexible and is for an electrical communication between the microcontroller and the at least one touch keypad.

2. A smart product configured for tasks comprising a data collection and a data transmission in an industry without restricting a movement of a user/operator, wherein the smart product is configured by being mounted on at least one textile material; the at least one textile material is completely or partially wearable by the user/operator, wherein
at least one electronic card is flexible and configured by being placed inside a textile product material (a textile product comprising plastic or similar flexible materials, and all kinds of fabrics) and the at least one electronic card is for an electrical communication between electronic components,
at least one touch keypad is positioned on an upper part of the at least one electronic card, wherein the at least one touch keypad is on an upper surface of the at least one textile material, and the at least one touch keypad is for enabling a manual data entry for a transmission of data,
a microcontroller is configured to sense touches on keys and the microcontroller is configured for transmitting the touches outside via an electronic interface.

3. The smart product according to claim 1, comprising an electronic card base surface, wherein the electronic card base surface is flexible.

4. The smart product according to claim 1, wherein the at least one touch keypad is embroidered on the at least one textile material (a fabric) with conductive yarns.

5. The smart product according to claim 1, comprising conductive key structures, wherein the conductive key structures are provided on the flexible electronic card and the conductive key structures facilitate a capacitive sensing of the touches on the at least one touch keypad.

6. The smart product according to claim 1, wherein the at least one touch keypad is integrated on the at least one textile material by means of embroidery, horizontal embroidery and/or weaving and sewing.

7. The smart product according to claim 1, comprising an electronic card base surface, wherein the electronic card base surface is formed of a polyamide material and is flexible.

8. The smart product according to claim 1, comprising an electronic card base surface, wherein the electronic card base surface is formed of a polyether ketone material and is flexible.

9. The smart product according to claim 1, comprising an electronic card base surface, wherein the electronic card base surface is formed of a transparent conductive polyester material and is flexible.

10. The smart product according to claim 1, comprising an electronic card base surface, wherein the electronic card base surface has a flexible structure by means of applying a conductive ink on a fabric.

11. The smart product according to claim 1, comprising at least one insulation layer, wherein the at least one insulation layer is coated on a lower and/or upper surface of the flexible electronic card.

12. The smart product according to claim 6, comprising an insulation layer, wherein the insulation layer is formed of a film or a band.

13. The smart product according to claim 1, wherein the at least one touch keypad is configured on a flexible surface.

14. The smart product according to claim 1, comprising a textile product, wherein the textile product is a glove.

15. The smart product according to claim 1, comprising a textile product, wherein the textile product is a wearable object.

16. The smart product according to claim 1, comprising at least one battery holder on a textile product and at least one battery, wherein the at least one battery is placed into the at least one battery holder.

17. The smart product according to claim 2, comprising an electronic card base surface, wherein the electronic card base surface is flexible.

18. The smart product according to claim 2, wherein the at least one touch keypad is embroidered on the at least one textile material (a fabric) with conductive yarns.

19. The smart product according to claim 2, comprising conductive key structures, wherein the conductive key structures are provided on the flexible electronic card and the conductive key structures facilitate a capacitive sensing of the touches on the at least one touch keypad.

20. The smart product according to claim 2, wherein the at least one touch keypad is integrated on the at least one textile material by means of embroidery, horizontal embroidery and/or weaving and sewing.
